(19) United States
(12) Patent Application Publication
(10) Pub. No.: US 2026/0295809 A1
(43) Pub. Date: Oct. 1, 2026

(54) Docking Accessory for Mobile Robots

(71) Applicant: Zebra Technologies Corporation, Lincolnshire, IL (US)

(72) Inventors: Matthew Wicks, St. Charles, MO (US); Charles Pitzer, San Jose, CA (US)

(73) Assignee: Zebra Technologies Corporation, Lincolnshire, IL (US)

(21) Appl. No.: 19/096,461

(22) Filed: Mar. 31, 2025

(51) Int. Cl. B25J 5/00; B25J 9/00; B25J 9/16; B25J 13/08

(52) U.S. Cl. CPC B25J 5/007; B25J 9/0009; B25J 9/161; B25J 13/08

(57) ABSTRACT

A mobile robot includes: a chassis; a coupling device disposed on the chassis, the coupling device having first and second docking surfaces movable between (i) a retracted configuration having a first distance between the first and second docking surfaces, and (ii) an extended configuration having a second distance between the first and second docking surfaces, the second distance being greater than the first distance; and a processor configured to: control the coupling device to place the first and second docking surfaces in the extended configuration for engagement with corresponding surfaces of a target object; and control the coupling device to place the first and second docking surfaces in the retracted configuration for disengagement from the corresponding surfaces of the target object.

### BACKGROUND

Autonomous or semi-autonomous mobile robots can be deployed in facilities such as warehouses, manufacturing facilities, healthcare facilities, or the like, e.g., to move items within the relevant facility. The items may be supported on carts or the like, and the robots may be configured to engage with (or dock), and disengage from, the carts to move the carts about the facility. The positional accuracy involved in docking with a cart, however, may lead to a mobile robot making multiple attempts to dock before succeeding.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of item-handling mobile robots deployed in a facility

FIG. 2A is a diagram of a mobile robot of FIG. 1.

FIG. 2B is a diagram of certain internal components of the mobile robot of FIG. 2A.

FIG. 3A is a diagram of a docking accessory for the mobile robot of FIG. 2A.

FIG. 3B is a diagram of the docking accessory of FIG. 3A when mounted on the mobile robot.

FIG. 4 is a diagram of a docking plate on a cart.

FIG. 5A is a diagram of a portion of the docking accessory of FIG. 3A in a retracted configuration.

FIG. 5B is a diagram of a portion of the docking accessory of FIG. 3A in an extended configuration.

FIG. 5C is a diagram of a docking process involving the docking accessory shown in FIGS. 5A and 5B, and the docking plate of FIG. 4.

FIG. 6A is a diagram of another example docking plate.

FIG. 6B is a diagram of a portion of a docking accessory in a retracted configuration.

FIG. 6C is a diagram of a portion of a docking accessory in an extended configuration.

FIG. 6D is a diagram of a docking process involving the docking accessory shown in FIGS. 6B and 6C, and the docking plate of FIG. 6A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a mobile robot, comprising: a chassis; a coupling device disposed on the chassis, the coupling device having first and second docking surfaces movable between (i) a retracted configuration having a first distance between the first and second docking surfaces, and (ii) an extended configuration having a second distance between the first and second docking surfaces, the second distance being greater than the first distance; and a processor configured to: control the coupling device to place the first and second docking surfaces in the extended configuration for engagement with corresponding surfaces of a target object; and control the coupling device to place the first and second docking surfaces in the retracted configuration for disengagement from the corresponding surfaces of the target object.

Additional examples disclosed herein are directed to a docking accessory, comprising: a base configured for connection with a chassis of a mobile robot; a coupling device disposed on the chassis, the coupling device having first and second docking surfaces movable between (i) a retracted configuration having a first distance between the first and second docking surfaces, and (ii) an extended configuration having a second distance between the first and second docking surfaces, the second distance being greater than the first distance; and a communications interface configured to communicatively connect the coupling device with a processor.

Further examples disclosed herein are directed to a kit, comprising: a docking accessory including: a base for connection with a chassis of a mobile robot; and a coupling device extending from the base, the coupling device having first and second docking surfaces movable between (i) a retracted configuration having a first distance between the first and second docking surfaces, and (ii) an extended configuration having a second distance between the first and second docking surfaces, the second distance being greater than the first distance; and a dock including a recess configured to receive the coupling device, the recess defining opposing walls configured to engage the first and second docking surfaces.

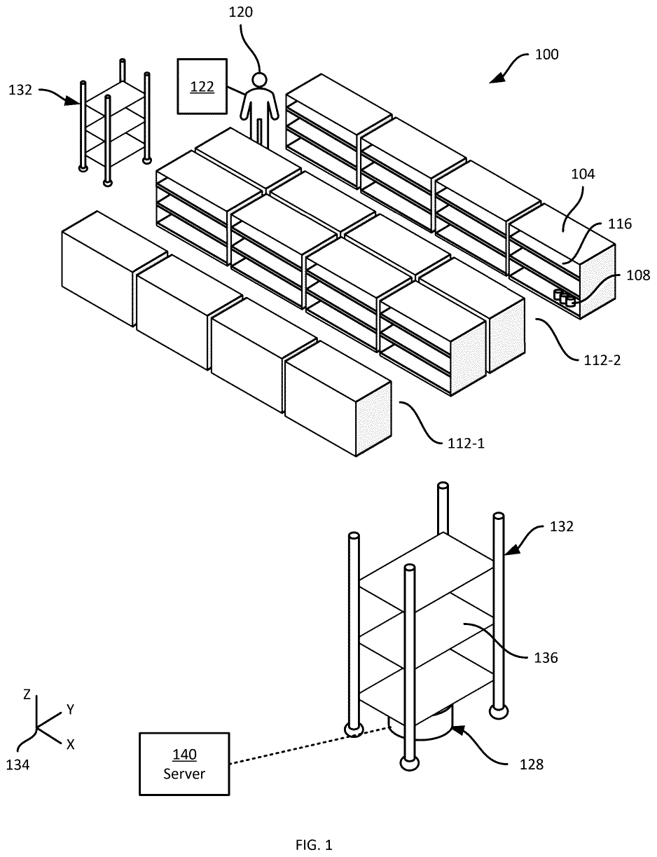

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as the aisles 112, and generically referred to as an aisle 112; similar nomenclature may be used herein for other components with hyphenated reference numbers). In the examples shown in FIG. 1, the support structures 104 include support surfaces 116 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1.

In other examples, the facility 100 can include fewer aisles 112 than shown, or more aisles 112 than shown in FIG. 1. The aisles 112, in the illustrated example, are formed by sets of support structures 104 (four on each side, although it will be understood that the aisles 112 may have a variety of lengths defined by varying numbers of support structures 104). The facility 100 can also have a wide variety of other aisle layouts, however. As will be apparent, each aisle 112 is a space open at opposing ends, and bounded on either side by one or more support structures 104. The aisles 112 can be travelled by humans, certain vehicles, and the like. In still further examples, the facility 100 need not include aisles 112, and can instead include assembly lines, or the like.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by a picker 120, such as a human worker. Although one picker 120 is shown in FIG. 1, it will be understood that various numbers of pickers can be deployed in the facility 100, e.g., depending on the size of the facility 100, the rate at which orders are received for fulfillment, and the like. Each picker 120 can operate a client computing device 124, such as a tablet computer, a smartphone, a wearable computer, or the like. The client device 124 enables the presentation of information to the picker 120, the capture of information from the picker 120, e.g., indicating completion of a pick task, or the like.

Order fulfillment in the facility 100 can be assisted by mobile robots, of which an example robot 128 is shown in FIG. 1. Additional robots 128 can be deployed in the facility 100, for example based on the size and/or layout of the facility 100. As will be discussed below, the facility 100 may contain a greater number of robots 128 than pickers 120 in some embodiments. In other embodiments, a number of robots 128 deployed in the facility 100 may be smaller than a number of pickers 120 in the facility 100.

To perform an order fulfillment task, or a portion thereof, the picker 120 can retrieve one or more items 108 from a support structure 104, and place the items 108 on a movable support, such as a wheeled cart 132 having one or more shelves or other support surfaces 136. Two example carts 132 are shown in FIG. 1, but it will be understood that the number of carts 132 deployed in the facility 100 may vary according to the size of the facility and/or other operational considerations. Further, the number of carts 132 deployed in the facility 100 need not match either of the number of robots 128, or the number of pickers 120.

The items 108 involved in fulfilling an order may be on support structures 104 at various locations in the facility. A given cart 132 may be moved about the facility 100 to collect the relevant items 108 for the order, e.g., before being moved to a pack-out area or the like. Moving of the cart 132 to various locations in the facility 100 can be performed by the robot 128. The robot 128 can navigate through the facility 100 while tracking its pose (e.g., location and orientation) relative to a coordinate system 134 previously established in the facility 100. The robot 128 can dock with a cart 132 and therefore move the cart about the facility during such navigation. The robot 128 can receive target locations to navigate to, e.g., to collect a cart 132, and to move that cart 132 to a sequence of pick locations to receive items 108 from the support structures 104 (e.g., placed on the cart 132 by the picker 120). The target locations, and/or other control data, can be received at the robot 128 from a server 140 or other suitable computing device via one or more communication networks deployed within the facility 100. In other examples, the robot 128 can also be configured to dock with a target object other than a cart 132. For example, the robot 128 can be configured to transport equipment between locations in the facility 100 by docking with the equipment and navigating to such locations towing the docked equipment.

When the robot 128 approaches a cart 132, the robot 128 can initiate a docking procedure that involves positioning the robot in a predetermined pose relative to the cart 132 (e.g., dependent on the direction in which the robot 128 is intended to move the cart 132), and activating a docking accessory to mechanically couple the robot 128 to the cart 132. Mitigating unexpected movements of the cart 132 during transit involves limiting or substantially eliminating movement of the cart 132 relative to the robot 128 when docked. The docking accessory may therefore have tight tolerances, and the robot 128 may be required to position itself relative to the cart 132 with a high degree of accuracy. Errors in localization by the robot 128 may lead to a failed docking attempt, followed by an attempt to correct the position of the robot 128 relative the cart 132 and a repeated attempt to dock with the cart 132. Each such attempt consumes time, reducing the availability of the robot 128 and the cart 132 for order fulfillment or other suitable tasks.

The robot 128, as discussed below, can include a docking accessory that provides a robust mechanical connection with the cart 132, e.g., limiting or eliminating movement of the cart 132 relative to the robot 128, while also increasing the likelihood of successful docking on any given docking attempt. In other words, the docking accessories described herein may permit successful docking by the robot 128 in the presence of localization errors sufficient to cause docking failures in certain other docking accessories.

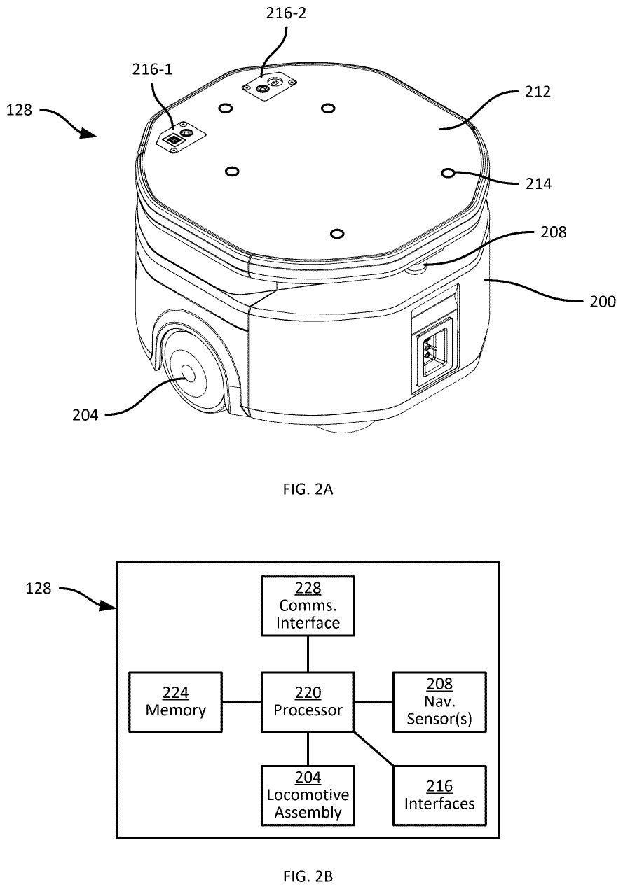

Before discussing the above-mentioned docking accessories in greater detail, certain components of the robot 128 are discussed with reference to FIGS. 2A and 2B. As shown in FIG. 2A, the robot 128 includes a chassis 200 supporting various other components of the robot 128. In particular, the chassis 200 supports a locomotive assembly 204, such as one or more electric motors, e.g., powered by an onboard battery or other suitable power source, driving a set of wheels, tracks, or the like. The locomotive assembly 204 can include one or more sensors such as a wheel odometer, an inertial measurement unit (IMU), and the like. The chassis 200 also supports one or more navigational sensors 208, such as one or more cameras and/or depth sensors (e.g., lidars, depth cameras, time-of-flight cameras, or the like). The sensor(s) 208 can be configured to capture image and/or depth data depicting at least a portion of the physical environment of the robot 128. Data captured by the sensor(s) 208 can be used by processing hardware of the robot 128 for navigational purposes, e.g., path planning, obstacle avoidance, and the like.

The chassis 200 can also define a mounting surface 212, e.g., on an upper wall of the chassis 200, for removably receiving one or more accessories. The mounting surface 212 can removably receive a docking accessory, as described below. The docking accessory can be affixed to the chassis 200 via fasteners such as bolts or the like, removably received in openings 214 on the mounting surface 212. The mounting surface 212 can also include one or more interface assemblies 216-1 and 216-2. The assembly 216-1 includes, in this example, a communications interface such as a Universal Serial Bus (USB) port, and a power delivery port. The assembly 216-2 includes, in this example, a communications interface such as an Ethernet port (e.g., an RJ-45 port), and a further power delivery port. A variety of other interface assembly configurations can also be implemented, e.g., incorporating two or more communications interfaces in one assembly 216 rather than divided between the assemblies 216-1, 216-2 as shown in FIG. 2.

FIG. 2B is a block diagram of certain components of the robot 128, including certain internal components not shown in FIG. 2A. In particular, the robot 128 includes a processor 220, e.g., one or more central processing units (CPUs), graphics processing units (GPUs), or dedicated hardware controllers such as application-specific integrated circuits (ASICs). The processor 220 is communicatively coupled with a non-transitory computer readable medium such as a memory 224, e.g., a suitable combination of volatile and non-volatile memory elements. The memory 224 stores various data used for autonomous or semi-autonomous navigation, including computer-readable instructions executable by the processor 220 to implement navigational and other task execution functions.

The processor 220 is also coupled with a communications interface 228, such as a wireless transceiver enabling the robot 128 to communicate with other computing devices, such as the server 140, client device 124, and other robots 128. The processor 220 can also be communicatively connected with the interface assemblies 216 mentioned above, e.g., to control accessories such as a docking accessory affixed to the chassis 200, and in some implementations, to receive sensor data from such accessories.

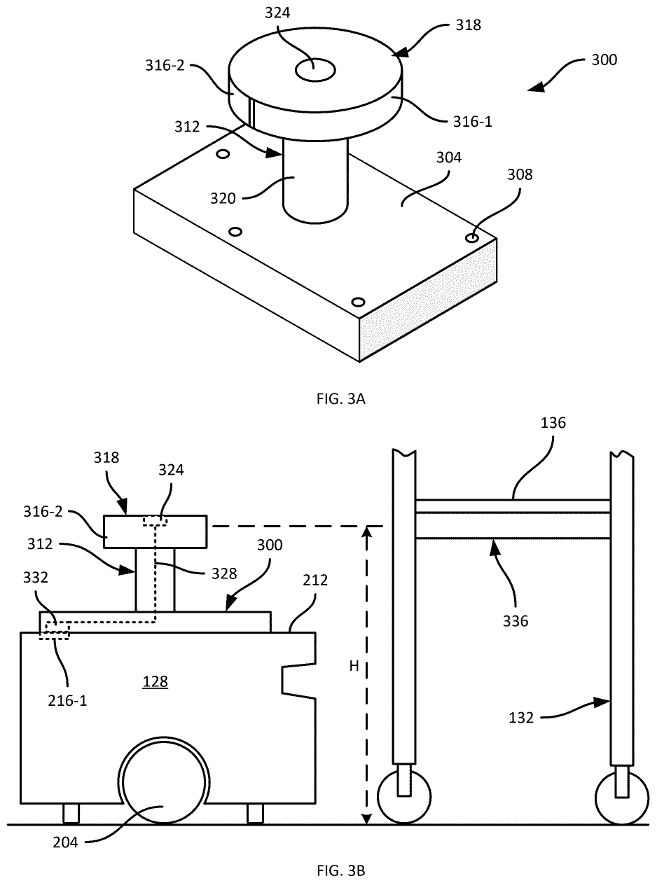

Turning to FIG. 3A, a docking accessory 300 is shown in isolation. The docking accessory 300 can be affixed to the chassis 200 of the robot 128, e.g., to the mounting surface 212, as shown in FIG. 3B. The docking accessory 300 includes a base 304 configured to engage with the mounting surface 212, e.g., by way of bolts or other suitable fasteners extending through apertures 308 defined through the base 304 into the openings 214 of the mounting surface 212. Various other mechanisms for fastening the docking accessory 300 to the chassis 200 can also be employed, such as snap-fit features on the mounting surface 212 and complementary latching features on the base 304. In other examples, the docking accessory 300 can be non-removably affixed to the chassis 200, e.g., as an integral component of the chassis 200.

The accessory 300 also includes a coupling device 312 disposed on the base 304, and defining at least first and second docking surfaces 316-1 and 316-2 that are movable between extended and retracted configurations. As will be seen below, the coupling device 312 can include additional docking surfaces 316 in some embodiments. The docking surfaces 316 are movable between the extended and retracted configurations in a plane parallel to the plane of travel of the robot 128 (e.g., the ground). In the illustrated example, the docking surfaces 316 are defined by an expandable disk 318 supported on a stalk 320 or other suitable structure extending substantially upwards from the base 304 (e.g., away from the ground on which the robot 128 travels). Movement of the docking surfaces 316 via expansion of the disk 318 is described below in greater detail.

The docking accessory 300 can also include a sensor 324, e.g., disposed on the disk 318. The sensor can be configured to detect a feature of a target object such as a cart 132. As seen in FIG. 3B, the sensor 324 is communicatively connected (e.g., via signal leads 328 and an interface 332 complementary to an interface 216 of the robot 128). The processor 220 of the robot 128 can therefore obtain sensor data from the sensor 324 and determine whether a predetermined feature of the target object is proximal to the sensor 324. For example, the cart 132 or a component thereof can include a magnet located at or near a target docking position for the disk 318, such that the sensor 324, e.g., a Hall effect sensor, detects the magnet when the disk 318 is in position for docking with the cart 132. The processor 220 can, for example, activate the disk or other suitable coupling device to dock with the cart 132 in response to such detection.

In other examples, the sensor 324 can include an image sensor, a photodiode, or the like, configured to detect a visual feature of the cart 132 such as a barcode, fiducial marker, or the like, instead of or in addition to the magnet mentioned above. In further examples, as described further below, the sensor 324 can include a current sensor or the like, configured to detect the presence of electrical current flowing from the cart to the coupling device 312. According to additional embodiments of the present disclosure, the sensor 324 can be disposed on the base 304 of the docking accessory 300. In still further embodiments of the present disclosure, image and/or depth data from the sensors 208 of the robot 128 can be configured to determine whether a predetermined feature of the target object is proximal to the disk 318.

As shown in FIG. 3B, when the accessory 300 is coupled to the mounting surface 212 of the robot 128, the docking surfaces 316 are supported at a fixed height “H”, e.g., relative to the plane on which the robot 128 travels. In other words, the coupling device 312 need not be height-adjustable relative to the chassis 200. As discussed in greater detail hereinbelow, the cart 132 includes a dock 336, e.g., affixed below a bottom support surface 136, that defines a recess to accommodate the disk 318. The dock 336 defines a channel or other suitable opening into the recess, guiding the disk 318 into the recess from an exterior of the cart 132 without adjusting a height of the disk 318. Control of the coupling device 312 may therefore be simplified relative to height-adjustable docking assemblies.

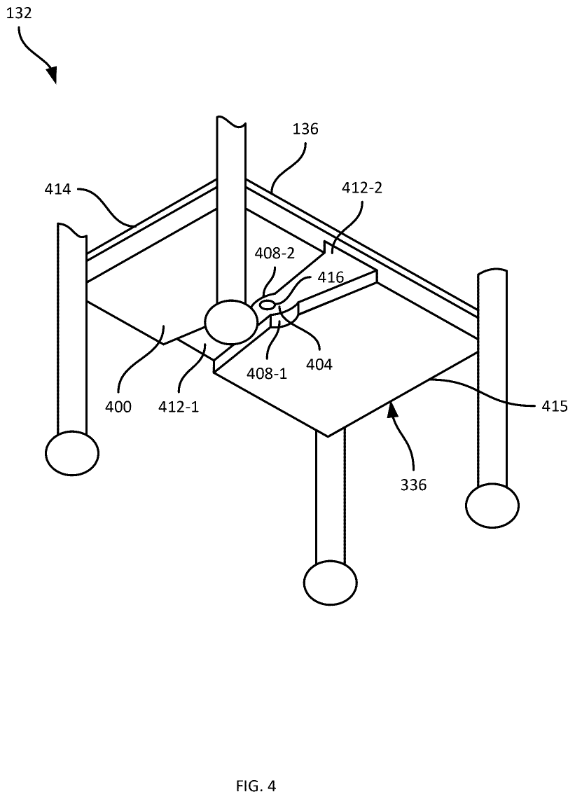

Turning to FIG. 4, a lower portion of the cart 132 is shown from below. The dock 336 can include a plate 400 affixed to an underside of a lower support surface 136 of the cart 132. The plate 400 can be integrally formed with the lower support surface 136 in some examples. In other examples, the plate 400 is removably attached to the lower support surface 136, e.g., via fasteners such as bolts extending into a complementary plate above the lower support surface 136, zip ties, or the like. A cart 132 can, in other words, be retrofitted with a plate 400 for use with a robot 128 having the docking accessory 300. For example, a docking kit may include one or more docking accessories 300, and one or more plates 400 as described herein.

The plate 400 can extend over substantially the entire area of the support surface 136, as in the illustrated example. In other examples, however, the plate need not extend over the entire area of the support surface 136. As shown, the plate 400 defines a recess 404, having side walls 408-1 and 408-2 configured to engage with the docking surfaces 316 of the coupling device 312, when the docking surfaces are in an extended position.

The plate 400 also defines one or more openings into the recess 404 from a perimeter of the plate 400. In this example, the plate 400 defines a first channel 412-1, and a second channel 412-2. The channels 412 are sufficiently wide (in a plane parallel to the plate 400) to allow passage of the coupling device 312 when in a retracted configuration, permitting the disk 318, in this example, to enter the channels 412 and guide the disk 318 into the recess 404. In other examples, the plate 400 can define additional channels for entry to the recess 404 from the forward end 414 of the cart 132 and/or the rear end 415 of the cart.

The dock 336 can also include a sensor target 416, such as the above-mentioned magnet, optical marker or the like, detectable by the sensor 324 (shown and described in connection with FIG. 3B). As seen in FIG. 4, the sensor target 416 can be disposed in or on a lower surface of the plate 400, within the recess 404, e.g., centered within the recess 404. As a result, the sensor 324 may detect the target 416 when the disk 318 is within the recess 404, indicating to the processor 220 that the coupling device 312 can be deployed to an extended configuration to affix the coupling device to the cart 132.

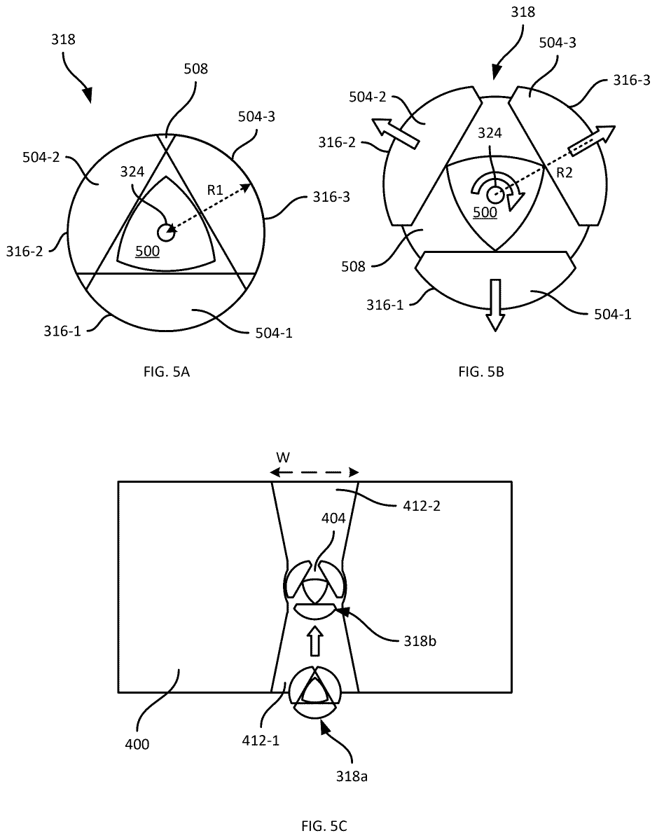

Referring to FIG. 5A and FIG. 5B, an example implementation of the expanding disk 318 is shown. The disk 318 can include a cam 500, e.g., rotatably supported on the stalk 320. Rotation of the cam 500 can be implemented via rotary solenoid or the like. The disk 318 can also include a plurality of lobes 504. In this example, the disk 318 includes a first lobe 504-1, a second lobe 504-2, and a third lobe 504-3, each defining respective docking surfaces 316-1, 316-2, and 316-3. The lobes 504 can be slidably mounted on a backing plate 508 or the like, permitting the lobes 504 to translate between the retracted position shown in FIG. 5A, and the extended position shown in FIG. 5B when the cam 500 rotates, e.g., about an axis of rotation centered (in this example) on the sensor target 416 (shown in FIG. 4). In the retracted configuration, a given point on lobe 504 is at a first distance from a given point on another lobe 504, and the disk 318 has a first radius R1. In the extended configuration, the above-mentioned points (that is, portions of the docking surfaces 316) are at a second distance from one another, greater than the first distance. The radius of the disk 318 also increases to a second radius R2, shown in FIG. 5B.

FIG. 5C shows a planar view of the plate 400 from below, illustrating an entry of the disk 318 into the channel 412-1, in the retracted configuration (labelled 318a in FIG. 5C). A width W of the channels 412 at the openings thereof is greater than the diameter of the disk 318 in the expanded configuration (labelled 318b in FIG. 5C) in this example. With the disk 318 in the retracted configuration, therefore, localization errors of up to several centimeters may present little or no impediment to successful docking. For example, the disk 318 may contact the walls of the channels 412 during travel towards the recess 404, and the angled walls of the channels 412 may guide the robot 128 (or shift the cart 132 into alignment with the robot 128). The disk 318 may, for example, rotate substantially freely about the shaft 320 in the retracted configuration, to mitigate frictional forces between the disk 318 (e.g., the docking surfaces 316 of the lobes 504) and the walls of the channel 412-1). When the disk 318 reaches the recess 404, e.g., and the sensor 324 detects the target 416, the processor 220 can deploy the disk 318 to the extended configuration. In the extended configuration, at least two of the lobes 504 engage with the walls of the recess 404, and affix the coupling device 312 to the cart 132. In some examples, the docking surfaces 316 can include surface features configured to promote frictional engagement between the disk 318 and the walls of the recess 404 in the docking plate 400. Such surface features can include textured surfaces, saw-tooth features extending from docking surfaces 316, rubberized surfaces, or the like. As will be apparent, the robot 128 can disengage from the cart 132 by returning the disk 318 to the retracted configuration.

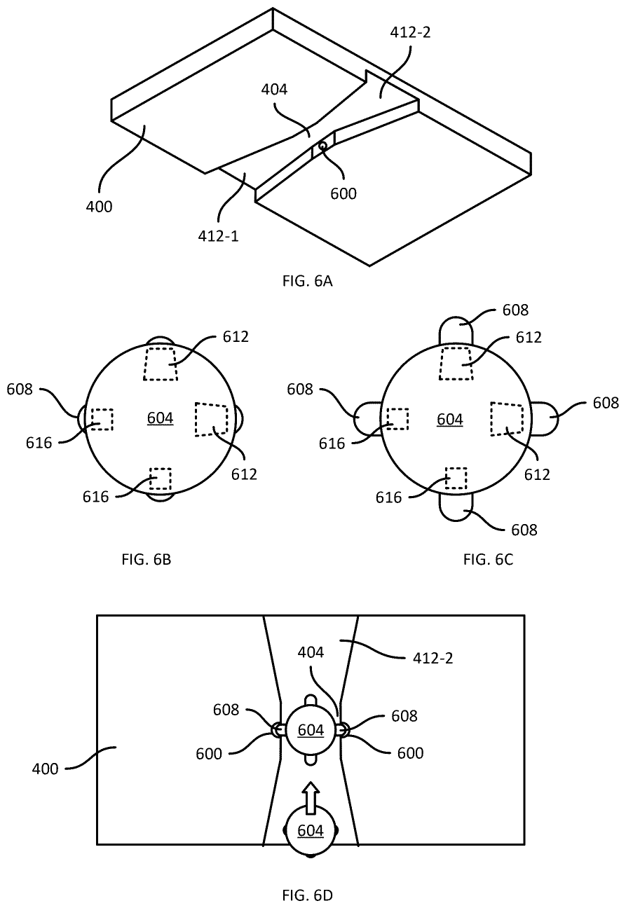

Various other structures are contemplated for the dock 336 and the docking accessory 300. For example, rather than a set of lobes 504 as shown in FIGS. 5A-5C, the disk 318 can include a set of casters or other rotary members disposed on shafts that can translate between extended and retracted positions. In further examples, turning to FIG. 6A, the plate 400 can include one or more apertures 600 in the walls of the recess 404. The coupling device 312, shown in FIGS. 6B and 6C, can include a head 604 movably supporting a plurality of extendable pins 608 (e.g., four pins in this example). The pins 608 can be movable between a retracted position, shown in FIG. 6B, and an extended position, shown in FIG. 6C. The pins 608 define docking surfaces, and in the extended position any given pair of pins 608 are at a greater distance from one another than in the retracted position.

As shown in FIG. 6D, extending the pins 608 results in certain pins 608 extending into the apertures 600, thus docking the robot 128 with the cart 132. As will be apparent, the robot 128 can disengage from the cart 132 by returning the pins to the retracted configuration. Once disengaged from the cart 132, the processor 220 can control the locomotive assembly 204 of the robot 128 to cause the disk 318 exit the channel 412 of the plate 400. Furthermore, according to some aspects of the present disclosure, the processor 220 can control the locomotive assembly 204 of the robot 128 to cause the disk 318 to rotate within the recess 404 by a predetermined amount (e.g., 90 degrees) and then reengage the disk 318 with the plate 400 (e.g., via pins 608 and apertures 600, or via lobes 504 and walls of the recess 404), thereby enabling orthogonal movement of the robot 128 relative to the cart 132. Those of ordinary skill in the art will understand that the disk 318 can comprise a greater number of pins 608 than shown in FIGS. 6B-D, thereby enabling non-orthogonal movement of the robot 128 relative to the cart 132.

The embodiment shown in FIGS. 6A-6D can also include a sensing mechanism to assist the processor 220 in navigating the robot 128 to place the coupling device in the recess 404, such as, for example, sensor 324 and sensor target 416 (discussed in connection with FIGS. 3A-4). Additionally, the head 604 can include, for each opposing pair of pins 608, a current emitter 612 and a current sensor 616. The processor 220 can control an emitter 612 to supply electrical current to a pin 608, and monitor the sensor 616 connected to the opposing pin. If the pins 608 are engaged with the plate 400, which may be conductive (or include a conductive element connecting the apertures 600), current sensed at the sensor 616 may indicate successful docking.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile robot, comprising:
a chassis;
a coupling device disposed on the chassis, the coupling device having first and second docking surfaces movable between (i) a retracted configuration having a first distance between the first and second docking surfaces, and (ii) an extended configuration having a second distance between the first and second docking surfaces, the second distance being greater than the first distance; and
a processor configured to:
control the coupling device to place the first and second docking surfaces in the extended configuration for engagement with corresponding surfaces of a target object; and
control the coupling device to place the first and second docking surfaces in the retracted configuration for disengagement from the corresponding surfaces of the target object.

2. The mobile robot of claim 1, wherein the coupling device extends from the chassis and supports the first and second docking surfaces at a fixed height above the chassis.

3. The mobile robot of claim 1, further comprising: a locomotive assembly coupled to the chassis, and configured to move the chassis in a first plane;
wherein the first and second docking surfaces are movable between the retracted configuration and the extended configuration in a plane parallel to the first plane.

4. The mobile robot of claim 1, wherein the processor is further configured to control the coupling device to place the first and second docking surfaces in the extended configuration in response to determining that the coupling device is adjacent to the corresponding surfaces of the target object.

5. The mobile robot of claim 4, further comprising:
a sensor configured to detect a feature of the target object;
wherein the processor is configured to determine that the coupling device is adjacent to the corresponding surfaces of the target object by determining that the sensor has detected the feature of the target object.

6. The mobile robot of claim 5, wherein the sensor includes at least one of:
an optical sensor,
a Hall effect sensor, or
a current sensor.

7. The mobile robot of claim 1, wherein the coupling device comprises:
an expanding disk including the first and second docking surfaces.

8. The mobile robot of claim 7, wherein the expanding disk comprises:
a first lobe defining the first docking surface;
a second lobe defining the second docking surface; and
a cam disposed between the first and second lobes.

9. The mobile robot of claim 1, wherein the coupling device comprises:
a first extendable pin defining the first docking surface;
a second extendable pin defining the second docking surface;
a head movably supporting the first and second extendable pins; and
an actuator assembly configured to selectively constrain movement of the first and second extendable pins.

10. A docking accessory, comprising:
a base configured for connection with a chassis of a mobile robot;
a coupling device disposed on the base, the coupling device having first and second docking surfaces movable between (i) a retracted configuration having a first distance between the first and second docking surfaces, and (ii) an extended configuration having a second distance between the first and second docking surfaces, the second distance being greater than the first distance; and
a communications interface configured to communicatively connect the coupling device with a processor.

11. The docking accessory of claim 10, wherein the coupling device extends upwards from the chassis to support the first and second docking surfaces at a fixed height above the chassis.

12. The docking accessory of claim 10, wherein the first and second docking surfaces are movable between the retracted configuration and the extended configuration in a plane parallel to a movement plane of the chassis.

13. The docking accessory of claim 10, further comprising:
a sensor configured to detect a feature of a target object.

14. The docking accessory of claim 13, wherein the sensor includes at least one of:
an optical sensor,
a Hall effect sensor, or
a current sensor.

15. The docking accessory of claim 10, wherein the coupling device comprises:
an expanding disk including the first and second docking surfaces.

16. The docking accessory of claim 15, wherein the expanding disk comprises:
a first lobe defining the first docking surface;
a second lobe defining the second docking surface; and
a cam disposed between the first and second lobes.

17. The docking accessory of claim 10, wherein the coupling device comprises:
a first extendable pin defining the first docking surface;
a second extendable pin defining the second docking surface;
a head movably supporting the first and second pins; and
an actuator assembly configured to selectively constrain movement of the first and second pins.

18. A kit, comprising:
a docking accessory including:
a base for connection with a chassis of a mobile robot; and
a coupling device extending from the base, the coupling device having first and second docking surfaces movable between (i) a retracted configuration having a first distance between the first and second docking surfaces, and (ii) an extended configuration having a second distance between the first and second docking surfaces, the second distance being greater than the first distance; and
a dock including a recess configured to receive the coupling device, the recess defining opposing walls configured to engage the first and second docking surfaces.

19. The kit of claim 18, wherein the dock comprises a plate configured for connection to an underside of a target object.

20. The kit of claim 18, wherein an opening into the recess is wider than the second distance.
